(19) United States
(12) Patent Application Publication
(10) Pub. No.: US 2009/0116152 A1
(43) Pub. Date: May 7, 2009

(54) MULTILAYER STITCHED YOKE FOR A HIGH DATA RATE PERPENDICULAR WRITE HEAD

(76) Inventors: Wen-Chien David Hsiao, San Jose, CA (US); Yimin Hsu, Sunnyvale, CA (US); Edward Hin Pong Lee, San Jose, CA (US); Vladimir Nikitin, Campbell, CA (US); Weihua Wang, San Jose, CA (US)

Correspondence Address: ZILKA-KOTAB, PC- HIT, P.O. BOX 721120, SAN JOSE, CA, 95172-1120, US

(21) Appl. No.: 11/935,284

(22) Filed: Nov. 5, 2007

(51) Int. Cl. G11B 5/33

(52) U.S. Cl. 360/314

(57) ABSTRACT

A magnetic write head for perpendicular magnetic data recording having a write pole that is sandwiched between first and second magnetic shaping layers. The split shaping layers allow a laminated shaping layer structure allows a manufacturable laminated shaping layer to be constructed for improved data rate. One of the magnetic shaping layers can be formed as a laminated structure while that other can be a single layer of electroplated magnetic material. The shaping layers can be separated from the write pole by a thin layer of non-magnetic material to form a laminated interface between the write pole and the shaping layers. These features reduce magnetic domains and also reduce eddy currents which advantageously improves data rate.

### FIELD OF THE INVENTION

The present invention relates to perpendicular magnetic recording and more particularly to a magnetic write head having a multi-layer stitched pole for decreasing eddy current and increasing data rate.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, referred to as a spacer layer, sandwiched between first and second ferromagnetic layers, referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to meet the ever increasing demand for improved data rate and data capacity, researchers have recently been focusing their efforts on the development of perpendicular recording systems. A traditional longitudinal recording system, such as one that incorporates the write head described above, stores data as magnetic bits oriented longitudinally along a track in the plane of the surface of the magnetic disk. This longitudinal data bit is recorded by a fringing field that forms between the pair of magnetic poles separated by a write gap.

A perpendicular recording system, by contrast, records data as magnetizations oriented perpendicular to the plane of the magnetic disk. The magnetic disk has a magnetically soft underlayer covered by a thin magnetically hard top layer. The perpendicular write head has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

### SUMMARY OF THE INVENTION

The present invention provides a magnetic write head designed for increased data rate recording. The write head includes a magnetic write pole that is located between first and second magnetic shaping layers.

One or both of the magnetic shaping layers can be separated from the write pole by a thin, electrically insulating, non magnetic layer. The presence of this electrically insulating, non-magnetic layer forms a laminated interface between the write pole and the shaping layer that advantageously reduces magnetic domains and eddy currents.

In addition, one of the magnetic shaping layers can be configured as a laminated structure with layers of magnetic material separated by thin non-magnetic layers. This structure further reduces the formation of magnetic domains and eddy currents, thereby further increasing the data rate of the write head.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view, taken from line 3-3 of FIG. 2 and rotated 90 degrees counterclockwise, of a magnetic write head according to an embodiment of the present invention; and

FIG. 4 is an enlarged view of a write pole and first and second shaping layers of a write head according to an embodiment of the invention.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

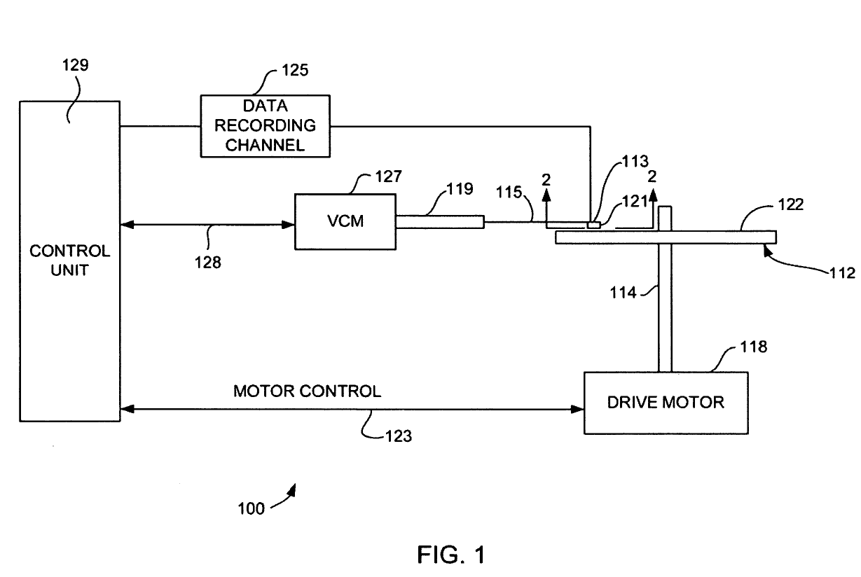

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

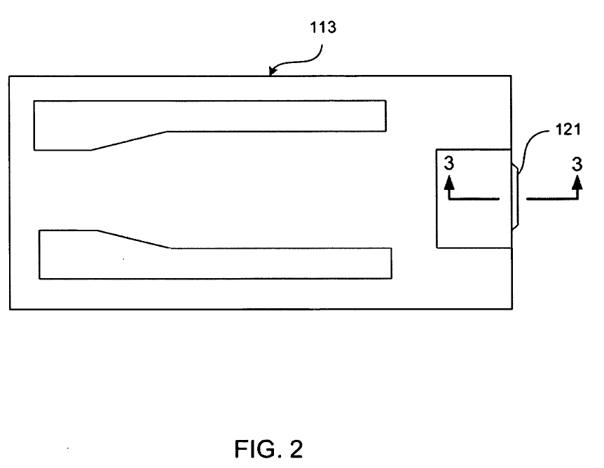

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

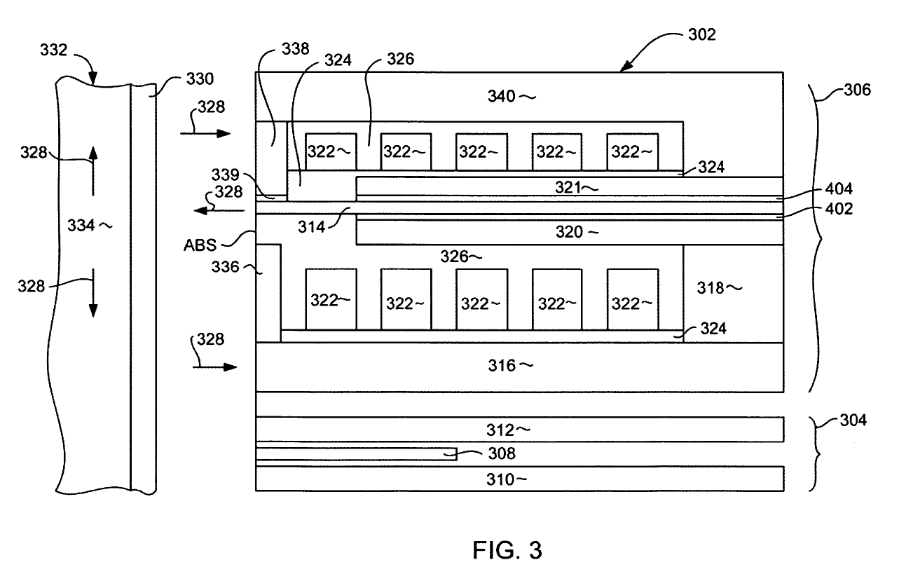

With reference now to FIG. 3, the invention can be embodied in a magnetic write head 302. The magnetic head 302 can include a read head portion 304 and a write head portion 306. The read head portion 304 can include a magnetoresistive sensor 308 such as a giant magnetoresistive sensor GMR, tunnel valve (TMR) etc. The magnetoresistive sensor 308 can be located between first and second magnetic shields 310, 312.

The write head 306 includes a write pole 314, having an end disposed toward an air bearing surface (ABS). The write head also includes a return pole 316, which also has an end disposed toward the ABS. The return pole 316 is magnetically connected with a magnetic back gap 318. The write pole 314 is magnetically coupled with first and second shaping layers 320, 321, which will be described in greater detail herein below. The write pole 314 and magnetic shaping layers 320, 321 are magnetically coupled with the return pole via the back gap layer 318. The non-magnetic layers 402, 404 can extend all of the way to the front and back edges of the shaping layers 320, 321 as shown (in which case the magnetic coupling between the write pole 314 and the shaping layers 320, 321 includes magnetostatic coupling. Alternatively, the non-magnetic layers 402, 404 can stop short of one or both of the front or back edges of the shaping layers 320, 321 so that at least a portion of the write pole 314 is directly magnetically connected with the shaping layers 320, 321.

The write pole 320 is preferably constructed of a high magnetic moment, low coercivity magnetic material, and is more preferably constructed as a laminate of layers of magnetic material separated by thin layers of non-magnetic material.

The write head 306 also includes an electrically conductive write coil 322, shown in cross section in FIG. 3. The write coil can be constructed of, for example, Cu and can be a pancake coil that wraps around the back gap 318 or can be a helical coil having upper and lower leads (as shown) disposed above and below tile write pole 314 and shaping layers 320, 321. The upper and lower leads of the write coil 322 can each be formed upon an insulating layer 324 and surrounded by a coil insulation layer 326, and the upper leads can be connected with certain of the bottom leads in regions into and out of the plane of the page and, therefore, not shown in FIG. 3.

During operation, a magnetic field from the write coil 322 causes a magnetic flux to flow through the shaping layer 320 and write pole 314. This causes a magnetic write field 328 to emit from the write pole 314 at the ABS. This write field 328 passes through a thin magnetically hard top layer 330 of an adjacent magnetic medium 332. The write field then travels through a magnetically soft under-layer 334 of the magnetic medium 332 before passing back to the return pole 316. The write field emitted from the write pole 314 locally magnetizes the magnetically hard top layer 330, thereby writing a bit of data. The return pole 316 has a cross section at the ABS that is much larger than that of the write pole 314 so that the write field 328 passing back to the return pole is sufficiently spread out that it does not erase the previously recorded bit.

A magnetic pedestal 336 can be provided, and can be magnetically connected with the return pole 316 at the ABS end of the return pole 316, extending toward, but not to the write pole 314. The magnetic pedestal can act as a shield to prevent stray fields, such as from the write coil 332 from inadvertently writing to the magnetic medium 332.

With reference still to FIG. 3, the write head 306 may also include a trailing magnetic shield 338, which is separated from the write pole 314 by a trailing gap 339. The presence of the trailing magnetic shield 338 increases the field gradient of the write field 328, thereby increasing the recording density with which the write head 306 can write data. The trailing shield 338 can be magnetically connected with the back portion of the write head 306 by a magnetic upper or trailing return pole 340 or could just be a floating design.

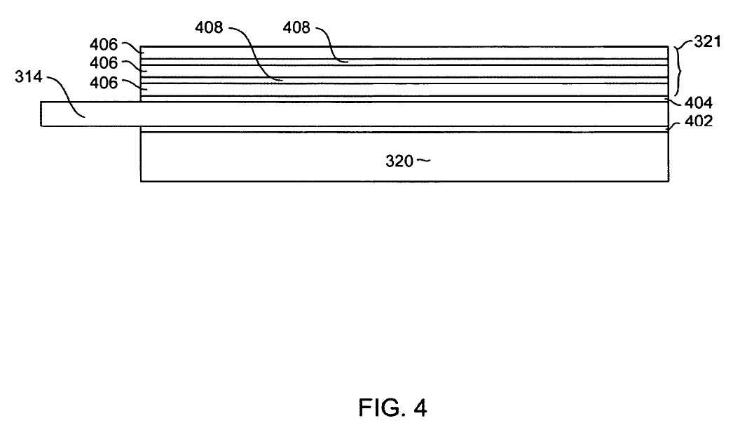

With reference now to FIG. 4, which shows the write pole 314 and shaping layers 320, 321 enlarged, the relationship between the write pole 314 and shaping layers 320, 321 can be more clearly understood. The write pole 314 is sandwiched between first and second magnetic shaping layers 320, 321. One or both of the magnetic shaping layers 320, 321 can be separated from the write pole 314 by a thin, non-magnetic, electrically insulating layer 402, 404, so that the write pole 314 non-magnetic layers 402, 404 and shaping layers 320, 321 together form a laminated structure that has a more favorable magnetic domain formation for the faster magnetic switching of the magnetic layers 320, 321, 314 which increases the recording data rate. The eddy current loss is also reduced with the laminate structure, which increases the recording data rate as well. The non-magnetic, electrically insulating layers 402, 404 can be constructed of alumina or some other non-magnetic, electrically insulating material, and can each have a thickness of 5 to 100 Angstroms.

The first, or lower shaping layer 320 can be constructed as a single layer of magnetic material such as CoFe or NiFe, which can be formed by electroplating into a photoresist frame structure. The second, or upper, shaping layer 321 could also be constructed as a single layer of electroplated, magnetic material such as CoFe or NiFe, but is preferably a laminated structure such as that shown. The second shaping layer 321 can, therefore, be constructed as a plurality of magnetic layers 406 separated from one another by thin, non-magnetic layers 408. The magnetic layers 406 can be CoFe, NiFe or some other suitable magnetic material.

If constructed as a laminated structure, the layers 406, 408 of the second shaping layer 321 can be constructed by sputter depositing the layers 406, 408 as full film layers, and then forming a mask structure (not shown) to cover areas where the upper shaping layer is to be. A material removal process can then be used to remove portions of the layers 406, 408 that are not protected by the mask structure. This process can be used to form when forming a laminated shaping layer, because the second shaping layer 321 is not constructed directly over the coils 322 (FIG. 3). The thickness of the non-magnetic layers 406 is typically 5 to 100 Angstroms. Although the shaping layer 321 is shown with three magnetic layers 406 and two non-magnetic layers 408, this is for purposes of illustration only, and some other number of layers could be used.

While it would be desirable to construct the lower shaping layer 320 as a laminated structure, the construction of such a laminated structure directly over the coils 322 (FIG. 3) is problematic. For example, sputter depositing a bottom shaping layer, in order to construct it with a laminated structure would require an ion milling process to remove the unwanted portions of the deposited layer, as described above with reference to the upper shaping layer 321. If this were done to construct the lower shaping layer, then the coils 322, below the lower shaping layer 320 would be damaged during the ion milling. Further, if the shaping layer were deposited sufficiently thick to form a laminated lower shaping layer, the mask would not be easily lifted off. A material removal process such as a CMP process would be needed to remove the mask structure, and the use of such a CMP process would make accurate control the thickness of shaping layer 320 very difficult. However, constructing the structure as a write pole 314 disposed between first and second split shaping layers, overcomes these challenges, allowing the upper shaping layer 321 to provide the benefits of a laminated structure, while allowing the lower shaping layer 320 to be constructed by electroplating to facilitate manufacturing and minimize damage to underlying layers such as the coil 322 (FIG. 3).

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic write head for perpendicular magnetic recording, comprising:
a first magnetic layer;
a second magnetic layer; and
a magnetic write pole, a portion of which is sandwiched between the first and second magnetic layers.

2. A magnetic write head as in claim 1 wherein the second magnetic layer comprises a plurality of layers of magnetic layers separated by thin non-magnetic layers.

3. A magnetic write head as in claim 1 wherein the first magnetic layer is a single layer of magnetic material and the second layer is a laminated structure comprising a plurality of magnetic layers, each separated from another by a thin layer of non-magnetic material.

4. A magnetic write head as in claim 3 wherein the thin layer of non-magnetic material comprises alumina.

5. A magnetic write head for perpendicular magnetic recording, comprising:
first and second magnetic shaping layers;
a magnetic write pole, at least a portion of which is disposed between the first and second magnetic shaping layers;
a thin layer of electrically insulating, non-magnetic material sandwiched between the write pole and at least one of the magnetic shaping layers.

6. A magnetic write head as in claim 5 wherein the one of the first magnetic shaping layer comprises a single layer of magnetic material and the second magnetic layer comprises a lamination of magnetic layers and thin non-magnetic layers.

7. A magnetic write head as in claim 5 wherein the write pole contacts the first magnetic shaping layer and wherein the thin layer of electrically insulating, non-magnetic material is sandwiched between the write pole and the second magnetic shaping layer.

8. A magnetic write head as in claim 5 wherein the thin layer of electrically insulating, non-magnetic material has a thickness of 5 to 100 Angstroms.

9. A magnetic write head as in claim 5 wherein:
the first magnetic shaping layer is a single layer of magnetic material;
the second magnetic shaping layer is a lamination of magnetic layers and thin non-magnetic layers;
the first magnetic shaping layer contacts the write pole; and
the thin layer of electrically insulating, non-magnetic material is sandwiched between the write pole and the second magnetic shaping layer.

10. A magnetic write head as in claim 5 wherein:
the first magnetic shaping layer is a single layer of magnetic material;
the second magnetic shaping layer is a lamination of magnetic layers and thin non-magnetic layers;
the second magnetic shaping layer contacts the write pole; and
the thin layer of electrically insulating, non-magnetic material is sandwiched between the write pole and the first magnetic shaping layer.

11. A magnetic write head for perpendicular magnetic data recording, comprising:
first and second magnetic shaping layers;
a magnetic write pole, a portion of which is disposed between the first and second magnetic shaping layers;
a first thin layer of electrically insulating, non-magnetic material sandwiched between the first magnetic shaping layer and the write pole; and
a second thin layer of electrically insulating, non-magnetic material sandwiched between the second magnetic shaping layer and the write pole.

12. A magnetic write head as in claim 11 wherein the first magnetic shaping layer is a single layer of magnetic material and the second magnetic shaping layer comprises a lamination of magnetic layers and thin non-magnetic layers.

13. A magnetic write head as in claim 11 wherein the first and second thin layers of electrically insulating, non-magnetic material each have a thickness of 5 to 100 Angstroms.

14. A magnetic write head as in claim 11 wherein the first magnetic shaping layer is a single layer of magnetic material and the second magnetic shaping layer comprises a plurality of layer of CoFe each of the layers of CoFe being separated from an adjacent one of the plurality of CoFe by a thin layer of alumina.

15. A magnetic write head for perpendicular magnetic data recording, comprising:
a first magnetic return pole having an end disposed toward an air bearing surface (ABS) and an end disposed away from the ABS;
a second magnetic return pole having an end disposed toward an air bearing surface and an end disposed away from an air bearing surface;
first and second magnetic shaping layers disposed between the first and second magnetic return poles each of the magnetic shaping layers being magnetically connected with the first and second magnetic return poles in a region removed from the ABS; and
a magnetic write pole disposed between the first and second magnetic shaping layers, the write pole being separated from at least one of the first and second magnetic shaping layers by a layer of electrically insulating non-magnetic material.

16. A magnetic write head as in claim 15 wherein the write pole is separated from each of the first and second magnetic shaping layers by a layer of electrically insulating, non-magnetic material.

17. A magnetic write head as in claim 15 wherein at least one of the first and second magnetic layers is a laminated structure comprising a plurality of magnetic layers each separated from an adjacent one of the plurality of magnetic layers by a thin layer of non-magnetic material.

18. A magnetic write head as in claim 15 wherein at least one of the first and second magnetic layers is a laminated structure comprising a plurality layers of CoFe each separated from an adjacent one of the layers of CoFe by a thin layer of alumina.

19. A magnetic write head as in claim 15 wherein the layer of electrically insulating, non-magnetic material has a thickness of 5 to 100 Angstroms.

20. A magnetic write head as in claim 15 wherein the layer of electrically insulating non-magnetic material comprises a layer of alumina having a thickness of 5 to 100 Angstroms.
